(19) United States
(12) Patent Application Publication
(10) Pub. No.: US 2014/0210814 A1
(43) Pub. Date: Jul. 31, 2014

(54) APPARATUS AND METHOD FOR VIRTUAL MAKEUP

(71) Applicant: Electronics & Telecommunications Research Institute, (US)

(72) Inventors: Jae Woo KIM, Daejeon (KR); Jin Seo KIM, Daejeon (KR); Ji Hyung LEE, Daejeon (KR); Soon Young KWON, Yangsan (KR); Song Woo LEE, Daejeon (KR); Ju Yeon YOU, Daegu (KR); In Su JANG, Daegu (KR); Yoon Seok CHOI, Daejeon (KR)

(73) Assignee: Electronics & Telecommunications Research Institute, Daejeon (KR)

(21) Appl. No.: 13/754,202

(22) Filed: Jan. 30, 2013

(30) Foreign Application Priority Data
Jan. 25, 2013 (KR) 10-2013-0008498

(51) Int. Cl. G06T 17/00

(52) U.S. Cl. CPC G06T 17/00
USPC 345/420; 345/629

(57) ABSTRACT

Provided are an apparatus and method for virtual makeup. The method for virtual makeup includes generating a virtual makeup history including pieces of information about a virtual makeup process, generating virtual makeup layers based on a plurality of related pieces of information among the pieces of information stored in the virtual makeup history, and generating a virtual makeup template by merging at least one of the virtual makeup layers. Accordingly, it is possible to reduce the time taken for a virtual makeup operation.

### CLAIM FOR PRIORITY

This application claims priority to Korean Patent Application No. 10-2013-0008498 filed on Jan. 25, 2013 in the Korean Intellectual Property Office (KIPO), the entire contents of which are hereby incorporated by reference.

### BACKGROUND

1. Technical Field

Example embodiments of the present invention relate in general to an apparatus and method for virtual makeup, and more particularly, to an apparatus and method for virtual makeup intended to apply a virtual makeup operation that has been performed in the past to a new face model.

2. Related Art

Virtual makeup means showing the effects of overlapping colors of cosmetics on a face model that is a two-dimensional (2D) image. A user carries out a virtual makeup operation using virtual cosmetics and virtual makeup tools as if he or she actually puts on makeup.

There needs to be a common makeup operation to be carried out for all such virtual makeup operations. The common makeup operation needs to be repeatedly performed every time a makeup operation is carried out on a new face model, and for this reason, unnecessary time is consumed. Also, to apply a virtual makeup operation that has been carried out in the past, to a new face model, a whole makeup operation needs to be performed again.

### SUMMARY

Accordingly, example embodiments of the present invention are provided to substantially obviate one or more problems due to limitations and disadvantages of the related art.

Example embodiments of the present invention provide a method for virtual makeup intended to carry out a makeup operation based on information about a virtual makeup process.

Example embodiments of the present invention also provide an apparatus for virtual makeup intended to carry out a makeup operation based on information about a virtual makeup process.

In some example embodiments, a method for virtual makeup includes: generating a virtual makeup history including pieces of information about a virtual makeup process; generating virtual makeup layers based on a plurality of related pieces of information among the pieces of information stored in the virtual makeup history; and generating a virtual makeup template by merging at least one of the virtual makeup layers.

Here, the virtual makeup history may include at least one piece of information among cosmetics information, makeup tool information, makeup stroke information, makeup area information, makeup intensity information, spectrum information about a makeup-finished target, and makeup time information.

Here, the makeup stroke information may include position information dependent on movement of a makeup tool.

Here, the makeup area information may include information about an area corresponding to position information dependent on movement of a makeup tool.

Here, the makeup area information may include reference position information about at least one element constituting a face model that is the makeup target, and vector information between pieces of the makeup area information.

Here, generating the virtual makeup layers may include generating the virtual makeup layers based on a relationship between the at least one piece of information based on one of the cosmetics information, the makeup tool information, and the makeup area information.

Here, the virtual makeup layers may have a tree structure based on a relationship between the plurality of related pieces of information.

Here, generating the virtual makeup template may include generating the virtual makeup template by merging the at least one virtual makeup layer according to passage of time with each other.

In other example embodiments, a method for virtual makeup includes: extracting makeup area information from a virtual makeup template including information about a virtual makeup process of a first face model; generating reference position information about at least one element constituting a second face model; setting an area on the second face model on which makeup will be applied based on the makeup area information and the reference position information; and applying virtual makeup on the area on which makeup will be applied based on the virtual makeup template.

Here, extracting the makeup area information may include extracting the makeup area information according to a sequence of the virtual makeup process.

Here, setting the area on which makeup will be applied may include: generating vector information about the makeup area information based on reference position information about at least one element constituting the first face model; mapping the vector information to the reference position information about the second face model; and setting an area defined by the mapped vector information as the area on which makeup will be applied.

Here, the virtual makeup template may include at least one virtual makeup layer, and the virtual makeup layer may include at least one piece of information among cosmetics information, makeup tool information, makeup stroke information, makeup area information, makeup intensity information, spectrum information about a makeup-finished target, and makeup time information.

Here, applying the virtual makeup may include applying the virtual makeup on the area on which makeup will be applied based on the at least one virtual makeup layer included in the virtual makeup template.

Here, applying the virtual makeup may include applying the virtual makeup on the area on which makeup will be applied based on the virtual makeup layer according to a sequence of the virtual makeup process performed on the first face model.

In other example embodiments, an apparatus for virtual makeup includes: a makeup history generator configured to generate a virtual makeup history including pieces of information about a virtual makeup process of a first face model; a makeup template generator configured to generate virtual makeup layers based on a plurality of related pieces of information among the pieces of information stored in the virtual makeup history, and generate a virtual makeup template by merging at least one of the virtual makeup layers; and a database configured to store information to be processed and information having been processed by the makeup history generator and the makeup template generator.

Here, the virtual makeup history may include at least one piece of information among cosmetics information, makeup tool information, makeup stroke information, makeup area information, makeup intensity information, spectrum information about a makeup-finished target, and makeup time information.

Here, the makeup template generator may generate the virtual makeup layers based on a relationship between the at least one piece of information based on one of the cosmetics information, the makeup tool information, and the makeup area information.

Here, the makeup stroke information may include position information dependent on movement of a makeup tool.

Here, the makeup area information may include information about an area corresponding to position information dependent on movement of a makeup tool.

Here, the apparatus for virtual makeup may further include a makeup applier configured to extract makeup area information from the virtual makeup template of the first face model, generate reference position information about at least one element constituting a second face model, set an area on the second face model on which makeup will be applied based on the makeup area information and the reference position information of the second face model, and apply virtual makeup on the area on which makeup will be applied based on the virtual makeup template.

### BRIEF DESCRIPTION OF DRAWINGS

Example embodiments of the present invention will become more apparent by describing in detail example embodiments of the present invention with reference to the accompanying drawings, in which:

FIG. 1 is a flowchart illustrating a method for virtual makeup according to an example embodiment of the present invention;

FIG. 2 is a block diagram of a makeup template generated in the method for virtual makeup according to the example embodiment of the present invention;

FIG. 3 is a flowchart illustrating a method for virtual makeup according to another example embodiment of the present invention;

FIG. 4 is a flowchart illustrating a process of setting an area in the method for virtual makeup according to the other example embodiment of the present invention;

FIG. 5 is a block diagram of an apparatus for virtual makeup according to an example embodiment of the present invention; and

FIG. 6 is a block diagram of an apparatus for virtual makeup according to another example embodiment of the present invention.

### DESCRIPTION OF EXAMPLE EMBODIMENTS OF THE PRESENT INVENTION

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims. Elements of the to example embodiments are consistently denoted by the same reference numerals throughout the drawings and detailed description.

It will be understood that, although the terms first, second, A, B, etc. may be used herein in reference to elements of the invention, such elements should not be construed as limited by these terms. For example, a first element could be termed a second element, and a second element could be termed a first element, without departing from the scope of the present invention. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.).

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

Hereinafter, example embodiments of the present invention will be described in detail with reference to the appended drawings. To aid in understanding the present invention, like numbers refer to like elements throughout the description of the figures, and the description of the same component will not be reiterated.

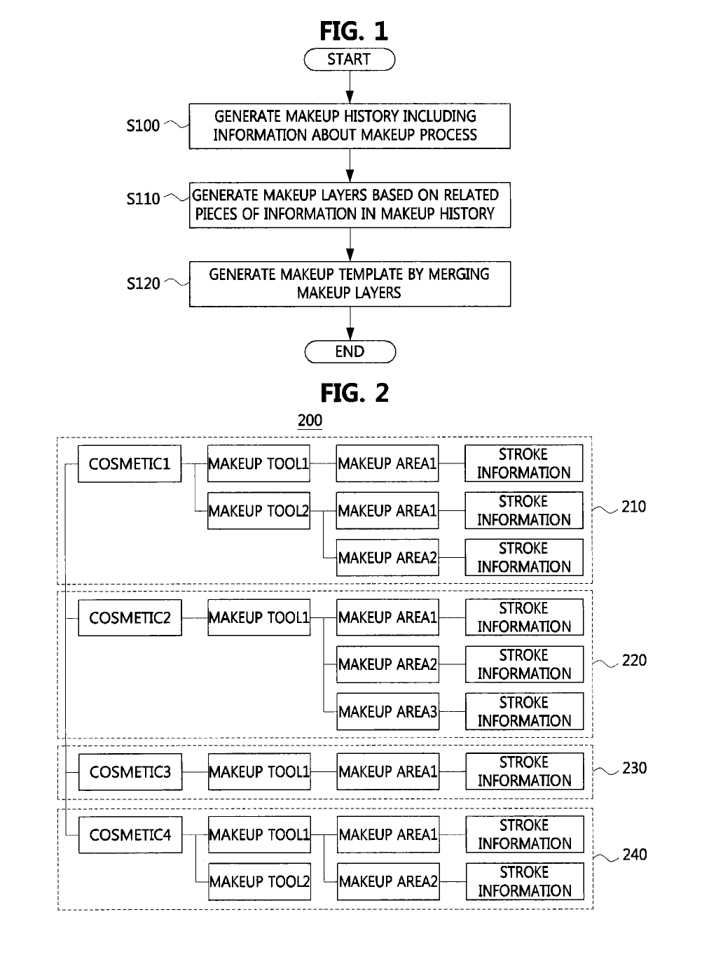

FIG. 1 is a flowchart illustrating a method for virtual makeup according to an example embodiment of the present invention.

Referring to FIG. 1, a method for virtual makeup according to an example embodiment of the present invention includes a step S100 of generating a makeup history in which pieces of information about a makeup process are stored according to passage of time, a step S110 of generating a makeup layer based on a plurality of related pieces of information among the pieces of information stored in the makeup history, and a step S120 of generating a makeup template by merging at least one makeup layer.

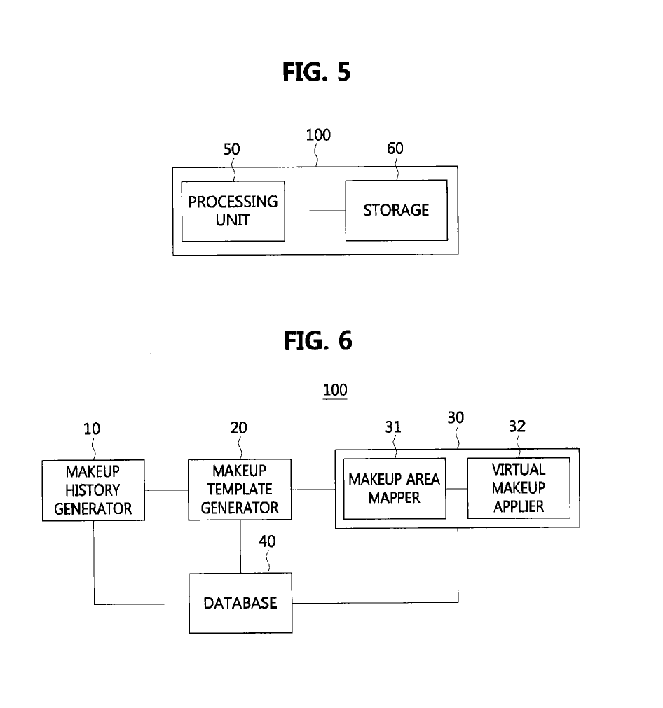

Here, the respective steps S100, S110, and S120 of the method for virtual makeup according to the example embodiment of the present invention may be performed by an apparatus 100 for virtual makeup shown in FIG. 5 or FIG. 6.

The apparatus for virtual makeup may generate a makeup history in which pieces of information about a virtual makeup process are stored according to passage of time (S100). The apparatus for virtual makeup may store pieces of information about a virtual makeup process for a face model that has been performed in advance by the apparatus for virtual makeup, or an apparatus for virtual makeup simulation prepared separately from the apparatus for virtual makeup, and generate a makeup history in which the stored pieces of information about the virtual makeup process are stored according to passage of time.

Here, the makeup history may denote a set of the pieces of information about the virtual makeup process, and the face model may denote a two-dimensional (2D) or three-dimensional (3D) image of a face.

For example, the apparatus for virtual makeup may store pieces of information about a skin care step, a primer step, a sun cream step, a makeup base step, a foundation step, a concealer step, a powder step, an eyebrow drawing step, an eyeshadow step, an eyeliner step, a mascara step, a lipstick step, a highlighter step, a shading step, etc. according to a sequence of virtual makeup. Based on such stored pieces of information, the apparatus for virtual makeup may generate a makeup history.

Here, the pieces of information about the virtual makeup process denote cosmetics information, makeup tool information, makeup stroke information, makeup area information, makeup intensity information, spectrum information, makeup time information, etc., and the apparatus for virtual makeup may store such pieces of information about the virtual makeup process according to passage of time.

The cosmetics information may include at least one of information about the type of cosmetics (e.g., a foundation, a power, and a lipstick) used in the virtual makeup process, information about cosmetics manufacturers, and information about cosmetic colors. In other words, the apparatus for virtual makeup may store pieces of information about the type of cosmetics used in the virtual makeup process, information about cosmetics manufacturers, and information about cosmetic colors, and generate cosmetics information including at least one of the stored pieces of information.

The makeup tool information may include information about the type of makeup tools (e.g., a brush, a sponge, and a powder puff) used in the virtual makeup process, information about the sizes of the makeup tools, and so on. In other words, the apparatus for virtual makeup may store pieces of information about the type of makeup tools used in the virtual makeup process and information about the sizes of the makeup tools, and generate makeup tool information including at least one of the stored pieces of information.

The makeup stroke information may denote position information dependent on movement of each of the makeup tools in the virtual makeup process. The apparatus for virtual makeup may present position information dependent on movement of a makeup tool in the form of (X, Y) in the case of a 2D face model, and in the form of (X, Y, Z) in the case of a 3D face model. Here, the apparatus for virtual makeup may generate position information dependent on movement of a makeup tool at predetermined time intervals, and generate makeup stroke information including the generated position information.

In addition, the makeup stroke information may include information about a start position and an end position of makeup applied using each of the makeup tools. For example, when start position information about makeup applied using a brush that is one of the makeup tools is (X1, Y1), and end position information about the makeup is (X2, Y2), the apparatus for virtual makeup may generate makeup stroke information including “(X1, Y1), (X2, Y2).”

The makeup area information may denote information about an area on the face model on which makeup is applied, and may be generated based on position information (i.e., makeup stroke information) dependent on movement of a makeup tool. Here, the area on which makeup is applied may denote an eye, a nose, a mouth, a cheek, a jaw, a forehead, etc. on the face model, and the area information may include at least one of an area, coordinates of the area, and coordinates of the central point of the area. The apparatus for virtual makeup may analyze position information dependent on movement of each makeup tool first, and generate makeup area information including at least one of an area on the face model indicated by the analyzed position information, coordinates of the area, and coordinates of the central point of the area.

For example, when makeup stroke information about a brush that is one of the makeup tools is “(X1, Y1), (X2, Y2),” the apparatus for virtual makeup may analyze an area indicated by “(X1, Y1), (X2, Y2)” on the face model, and when the area is analyzed to be a “cheek” area as a result, the apparatus for virtual makeup may generate the analysis result as makeup area information. Here, the apparatus for virtual makeup may generate makeup area information including at least one of the analyzed area, coordinates of the analyzed area, and coordinates of the central point of the analyzed area.

In addition, the makeup area information may include reference position information about at least one element constituting the face model, and vector information between pieces of the makeup area information. Elements constituting the face model may denote eyes, a nose, a mouth, ears, eyebrows, etc., and reference position information may denote the central point of each element constituting the face model. The vector information may include distance information between the central point of each element and the central point of the area indicated by the makeup area information, direction information from the central point of the element toward the central point of the area indicated by the makeup area information, and so on.

For example, when an element constituting the face model is an eye, and an area indicated by the makeup area information is a cheek, the apparatus for virtual makeup may generate distance information between the central point of the eye and the central point of the cheek, and direction information from the central point of the eye toward the central point of the cheek, and generate vector information including the generated distance information and the generated direction information.

The makeup intensity information may denote a pressure exerted on the face model using a makeup tool. The apparatus for virtual makeup may generate information about a pressure exerted on the face model using a makeup tool, and generate makeup intensity information including the generated pressure information.

The spectrum information may denote colors of the face model on which virtual makeup has been applied, and present the colors of the face model using a color model such as red, green and blue (RGB) or YCbCr. The apparatus for virtual makeup may analyze color information about the face model on which virtual makeup has been applied, and generate spectrum information including the analyzed color information.

The makeup time information may denote a time for which virtual makeup has been applied. The apparatus for virtual makeup may store information about a time for which each step of the virtual makeup process has been performed, information about a time for which cosmetics have been used, information about a time for which a makeup tool has been used, information about a time for which virtual makeup has been applied on the makeup area, and time information about strokes, and generate makeup time information including at least one of the stored pieces of time information.

The apparatus for virtual makeup may generate makeup layers based on a plurality of related pieces of information among the pieces of information stored in the makeup history (S110). In other words, the apparatus for virtual makeup may generate makeup layers according to a relationship between at least one piece of information related based on one of the cosmetics information, the makeup tool information, and the makeup area information. At this time, based on a relationship between a plurality of related pieces of information, the apparatus for virtual makeup may generate makeup layers having a tree structure.

For example, when the apparatus for virtual makeup generates a makeup layer according to a relationship between at least one piece of information based on the cosmetics information, the makeup layer may include information about an arbitrary cosmetic, information about at least one makeup tool for applying virtual makeup using the arbitrary cosmetic, at least one piece of stroke information dependent on movement of each of the at least one makeup tool, and information about a makeup area indicated by each of the at least one piece of stroke information. In other words, the apparatus for virtual makeup may generate a makeup layer having a tree structure according to a relationship between a makeup tool, stroke information, a makeup area, etc. based on cosmetics.

When the apparatus for virtual makeup generates a makeup layer according to a relationship between at least one piece of information based on the makeup tool information, the makeup layer may include information about an arbitrary makeup tool for applying virtual makeup, information about at least one cosmetic used with the arbitrary makeup tool, at least one piece of stroke information dependent on movement of the arbitrary makeup tool, and information about a makeup area indicated by each of the at least one piece of stroke information. In other words, the apparatus for virtual makeup may generate a makeup layer having a tree structure according to a relationship between cosmetics, stroke information, a makeup area, etc. based on makeup tools.

When the apparatus for virtual makeup generates a makeup layer according to a relationship between at least one piece of information based on the makeup area information, the makeup layer may include information about an arbitrary makeup area on which virtual make is applied, information about at least one cosmetic used for applying virtual makeup on the arbitrary makeup area, information about at least one makeup tool for applying virtual makeup using each of the at least one cosmetic, and at least one piece of stroke information dependent on movement of each of the at least one makeup tool. In other words, the apparatus for virtual makeup may generate a makeup layer having a tree structure according to a relationship between cosmetics, a makeup tool, and stroke information, etc. based on makeup areas.

The apparatus for virtual makeup may generate a makeup template by merging at least one of the makeup layers (S120). At this time, the apparatus for virtual makeup may generate a makeup template by merging at least one makeup layer according to passage of time. For example, when makeup layer 1, makeup layer 2, makeup layer 3, and makeup layer 4 are generated in sequence according to passage of time, the apparatus for virtual makeup may generate a makeup template by merging makeup layer 1, makeup layer 2, makeup layer 3, and makeup layer 4 in sequence.

FIG. 2 is a block diagram of a makeup template generated in the method for virtual makeup according to the example embodiment of the present invention.

Referring to FIG. 2, a makeup template 200 may include at least one makeup layer 210, 220, 230 and 240, and the makeup layers 210, 220, 230 and 240 may include cosmetics information, makeup tool information, makeup stroke information, and makeup area information. In addition, the makeup layers 210, 220, 230 and 240 may further include makeup intensity information, spectrum information, and makeup time information. Here, each of the makeup layers 210, 220, 230 and 240 denotes a makeup layer generated based on a relationship between at least one piece of information related based on cosmetics information.

The apparatus for virtual makeup may generate a first makeup layer 210 including cosmetics 1, makeup tool 1 and makeup tool 2 for applying virtual makeup using cosmetics 1, stroke information dependent on movement of makeup tool 1, makeup area 1 indicated by the stroke information about makeup tool 1, stroke information dependent on movement of makeup tool 2, and makeup area 1 and makeup area 2 indicated by the stroke information about makeup tool 2. In other words, the apparatus for virtual makeup may generate the first makeup layer 210 having a tree structure by connecting cosmetics 1, makeup tool 1, makeup tool 2, makeup area 1, makeup area 2, and the stroke information according to a relationship.

The apparatus for virtual makeup may generate a second makeup layer 220 including cosmetics 2, makeup tool 1 for applying virtual makeup using cosmetics 2, stroke information dependent on movement of makeup tool 1, and makeup area 1, makeup area 2 and makeup area 3 indicated by the stroke information about makeup tool 1. In other words, the apparatus for virtual makeup may generate the second makeup layer 220 having a tree structure by connecting cosmetics 2, makeup tool 1, makeup area 1, makeup area 2, makeup area 3, and the stroke information according to a relationship.

The apparatus for virtual makeup may generate a third makeup layer 230 including cosmetics 3, makeup tool 1 for applying virtual makeup using cosmetics 3, stroke information dependent on movement of makeup tool 1, and makeup area 1 indicated by the stroke information about makeup tool 1. In other words, the apparatus for virtual makeup may generate the third makeup layer 230 having a tree structure by connecting cosmetics 3, makeup tool 1, makeup area 1, and the stroke information according to a relationship.

The apparatus for virtual makeup may generate a fourth makeup layer 240 including cosmetics 4, makeup tool 1 and makeup tool 2 for applying virtual makeup using cosmetics 4, stroke information dependent on movement of makeup tool 1, makeup area 1 indicated by the stroke information about makeup tool 1, stroke information dependent on movement of makeup tool 2, and makeup area 2 indicated by the stroke information about makeup tool 2. In other words, the apparatus for virtual makeup may generate the fourth makeup layer 240 having a tree structure by connecting cosmetics 4, makeup tool 1, makeup tool 2, makeup area 1, makeup area 2, and the stroke information according to a relationship.

Here, the first makeup layer 210, the second makeup layer 220, the third makeup layer 230, and the fourth makeup layer 240 are sequentially generated according to passage of time in a virtual makeup process. The first makeup layer 210 denotes a makeup layer that has been generated at the very first, and the fourth makeup layer 240 denotes a makeup layer that has been generated at the very last.

In other words, the apparatus for virtual makeup may generate the first makeup layer 210 first according to a relationship between cosmetics information, makeup tool information, stroke information, and makeup area information, and then sequentially generate the second makeup layer 220, the third makeup layer 230, and the fourth makeup layer 240. The apparatus for virtual makeup may generate one makeup template 200 by merging at least one of these makeup layers 210, 220, 230 and 240 according to passage of time.

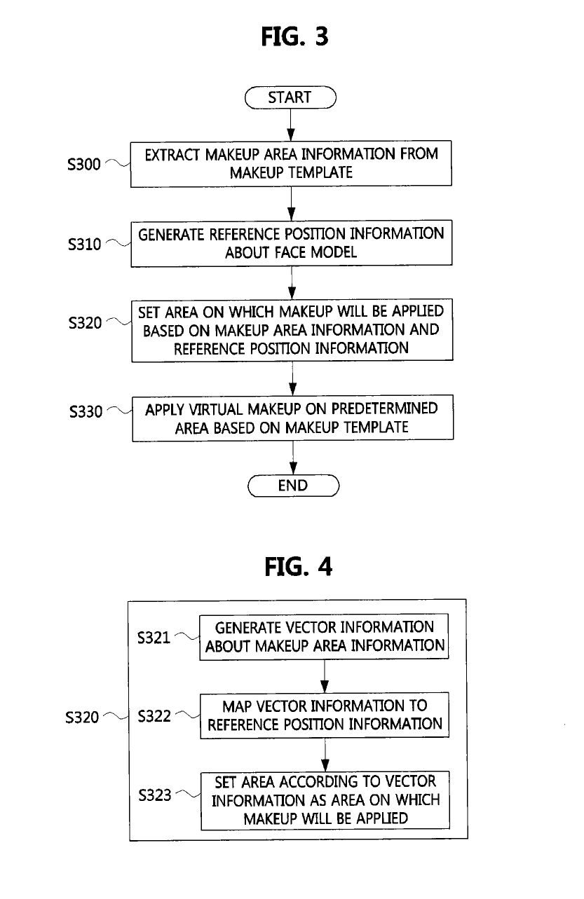

FIG. 3 is a flowchart illustrating a method for virtual makeup according to another example embodiment of the present invention, and FIG. 4 is a flowchart illustrating a process of setting an area in the method for virtual makeup according to the other example embodiment of the present invention.

Referring to FIG. 3 and FIG. 4, the method for virtual makeup according to the other example embodiment of the present invention includes a step S300 of extracting makeup area information from a virtual makeup template including information about a makeup process of a first face model, a step S310 of generating reference position information about at least one element constituting a second face model, a step S320 of setting an area on the second face model on which makeup will be applied based on the makeup area information and the reference position information, and a step S330 of applying virtual makeup on the area on which makeup will be applied based on the virtual makeup template.

Here, the step S320 of setting the area on the second face model on which makeup will be applied may include a step S321 of generating vector information about the makeup area information based on reference position information about at least one element constituting the first face model, a step S322 of mapping the vector information to the reference position information about the second face model, and a step S323 of setting an area according to the mapped vector information as the area on which makeup will be applied.

A face model may denote a 2D image or 3D image of a face. The first face model may denote a face model on which virtual makeup has already been applied, and the second face model may denote a face model on which virtual makeup will be newly applied. A makeup template for the first face model is generated before virtual makeup is applied to the second face model, and the generated makeup template is stored in a database in the apparatus for virtual makeup. In other words, the apparatus for virtual makeup may apply virtual makeup to the second face model using the makeup template for the first face model stored in the database.

Here, the respective steps S300, S310, S320 (S321, S322 and S323), and S330 may be performed by an apparatus 100 for virtual makeup shown in FIG. 5 or FIG. 6.

The apparatus for virtual makeup may extract the makeup area information from the makeup template including the information about the makeup process of the first face model (S300). The apparatus for virtual makeup may extract the makeup area information from the makeup template according to a sequence of a virtual makeup process. Referring to FIG. 2 described above, the apparatus for virtual makeup may extract makeup area 1 included in the first makeup layer of the makeup template, then makeup area 2 included in the first makeup layer, then makeup area 1 included in the second makeup layer, then makeup area 2 included in the second makeup layer, and then makeup area 3 included in the second makeup layer.

The makeup template may include pieces of information about the virtual makeup process, and the pieces of information about the virtual makeup process may be stored according to passage of time. The makeup template may include at least one makeup layer, and the makeup layer may include at least one makeup history.

The makeup history may include at least one piece of information among cosmetics information, makeup tool information, makeup stroke information, makeup area information, makeup intensity information, spectrum information, and makeup time information.

Here, the cosmetics information may include at least one of information about the type of cosmetics used in the virtual makeup process, information about cosmetics manufacturers, and information about cosmetic colors. The makeup tool information may include information about the type of a makeup tool used in the virtual makeup process, information about the sizes of the makeup tools, and so on.

The makeup stroke information may denote position information dependent on movement of each of the makeup tools in the virtual makeup process. The position information dependent on movement of a makeup tool may be presented in the form of (X, Y) in the case of a 2D face model, and in the form of (X, Y, Z) in the case of a 3D face model.

In addition, the makeup stroke information may include information about a start position and an end position of makeup applied using each of the makeup tools. For example, when start position information about makeup applied using a brush that is one of the makeup tools is (X1, Y1), and end position information about the makeup is (X2, Y2), the makeup stroke information may include “(X1, Y1), (X2, Y2).”

The makeup area information may denote information about an area on a face model on which makeup is applied, and may be generated based on position information (i.e., makeup stroke information) dependent on movement of a makeup tool. Here, the area on which makeup is applied may denote an eye, a nose, a mouth, a cheek, a jaw, a forehead, etc. on the face model, and the area information may include at least one of an area, coordinates of the area, and coordinates of the central point of the area.

In addition, the makeup area information may include reference position information about at least one element constituting the face model, and vector information between pieces of the makeup area information. Elements constituting the face model may denote eyes, a nose, a mouth, ears, eyebrows, etc., and reference position information may denote the central point of each element constituting the face model. Vector information may include a distance between the central point of each element and the central point of the area indicated by the makeup area information, a direction from the central point of the element toward the central point of the area indicated by the makeup area information, and so on.

The makeup intensity information may denote a pressure exerted on the face model using a makeup tool. The spectrum information may denote colors of the face model on which virtual makeup has been applied, and present the colors of the face model using a color model such as RGB or YCbCr. The makeup time information may denote a time for which virtual makeup has been applied, and include at least one piece of time information among information about a time for which each step of the virtual makeup process has been performed, information about a time for which cosmetics have been used, information about a time for which a makeup tool has been used, information about a time for which virtual makeup has been applied on the makeup area, and time information about strokes.

The apparatus for virtual makeup may generate the reference position information about the at least one element constituting the second face model (S310). Since elements constituting a face model denotes eyes, a nose, a mouth, ears, eyebrows, etc., and reference position information denotes the central point of each element constituting the face model, the apparatus for virtual makeup may generate the central point of the at least one element constituting the second face model, and reference position information including the generated central point.

The apparatus for virtual makeup may generate vector information about the makeup area information based on the reference position information about the at least one element constituting the first face model (S321). Here, the vector information may include distance information between a first position and a second position, and direction information from the first position toward the second position. In other words, the apparatus for virtual makeup may generate distance information between the central points (i.e., reference position information) of respective elements (e.g., eyes, a nose, a mouth, ears, and eyebrows) constituting the first face model and the central point of the area (e.g., an eye, a nose, a mouth, a cheek, a jaw or a forehead) indicated by the makeup area information, and direction information from the central points of the respective elements constituting the first face model toward the central point of the area indicated by the makeup area information, and generate vector information including the generated distance information and the generated direction information.

Meanwhile, when vector information is included in the makeup area information extracted in step S300, the apparatus for virtual makeup may omit step S321. In other words, the apparatus for virtual makeup may perform step S310 and then step S322.

The apparatus for virtual makeup may map the vector information to the reference position information about the second face model (S322). For example, when the vector information has been generated based on the central points of the eyes, noise, and mouth among the elements constituting the first face model, the apparatus for virtual makeup may map a first vector (i.e., a vector generated based on an eye of the first face model) to the central point of an eye that is an element constituting the second face model, a second vector (i.e., a vector generated based on the nose of the first face model) to the central point of a nose that is an element constituting the second face model, and a third vector (i.e., a vector generated based on the mouth of the first face model) to the central point of a mouth that is an element constituting the second face model.

The apparatus for virtual makeup may set an area according to the mapped vector information as an area on which makeup will be applied (S323). In other words, the apparatus for virtual makeup may set a point at which mapped vectors cross, or a point indicated by a mapped vector as an area on which virtual makeup will be applied. In the example described in step S322, the apparatus for virtual makeup may set a point at which at least two vectors among the first vector, the second vector, and the third vector cross as the central point of an area on which makeup will be applied. On the other hand, when there is no point at which the first vector, the second vector, and the third vector cross, the apparatus for virtual makeup may extend the first vector, the second vector, and the third vector in their longitudinal directions, and set a point at which at least two vectors among the extended first vector, the extended second vector, and the extended third vector cross as the central point of an area on which makeup will be applied.

Based on the makeup template, the apparatus for virtual makeup may apply virtual makeup on the area on which makeup will be applied (S330). The apparatus for virtual makeup may apply virtual makeup in a sequence of makeup layers included in the makeup template. Referring to FIG. 2, the apparatus for virtual makeup may apply virtual makeup based on the first makeup layer 210, then virtual makeup based on the second makeup layer 220, then virtual makeup based on the third makeup layer 230, and then virtual makeup based on the fourth makeup layer 240.

In other words, the apparatus for virtual makeup may apply virtual makeup on an area of the second face model corresponding to makeup area 1 based on cosmetics 1, makeup tool 1 and stroke information, and then apply virtual makeup on the area of the second face model corresponding to makeup area 1 based on cosmetics 1, makeup tool 2 and stroke information.

In the method for virtual makeup according to the other example embodiment of the present invention, it has been described that step S300 is performed first, and then step S310 is performed. However, the present invention is not limited to this sequence, and step S300 may be performed after step S310, or step S300 and step S310 may be performed at the same time.

A method for virtual makeup according to the example embodiment or the other example embodiment of the present invention can be implemented in the form of a program command that can be executed through a variety of computer means and recorded in a computer-readable medium. The computer-readable medium may include program commands, data files, data structures, etc. in a single or combined form. The program commands recorded in the computer-readable medium may be program commands that are specially designed and configured for the example embodiments of the present invention, or program commands that are publicized and available for those of ordinary skill in the art of computer software.

Examples of the computer-readable medium include hardware devices, such as a read-only memory (ROM), a random access memory (RAM), and a flash memory, specially configured to store and execute program commands. Examples of the program commands include advanced language codes that can be executed by a computer using an interpreter, etc., as well as machine language codes, such as those generated by a compiler. The hardware devices may be configured to operate as at least one software module so as to perform operations of the example embodiments of the present invention, and vice versa.

FIG. 5 is a block diagram of an apparatus for virtual makeup according to an example embodiment of the present invention, and FIG. 6 is a block diagram of an apparatus for virtual makeup according to another example embodiment of the present invention.

Referring to FIG. 5 and FIG. 6, an apparatus for virtual makeup 100 according to an example embodiment of the present invention includes a processing unit 50 and a storage 60, and an apparatus for virtual makeup 100 according to another example embodiment of the present invention includes a makeup history generator 10, a makeup template generator 20, a makeup applier 30 (including a makeup area mapper 31 and a virtual makeup applier 32), and a database 40.

Here, the processing unit 50 may be configured to include the makeup history generator 10 and the makeup template generator 20, to include the makeup applier 30, or to include the makeup history generator 10, the makeup template generator 20, and the makeup applier 30. The storage 60 may be considered to have substantially the same configuration as the database 40.

The processing unit 50 may generate a makeup history by storing pieces of information about a makeup process of a first face model according to passage of time, generate a makeup layer based on a plurality of related pieces of information among the pieces of information stored in the makeup history, and generate a makeup template by merging at least one makeup layer.

The processing unit 50 may generate a makeup history according to step S100 described above, and the makeup history generator 10 may also generate a makeup history according to step S100 described above.

Specifically, the processing unit 50 may store pieces of information about a virtual makeup process for the first face model that has been performed in advance by the apparatus 100 for virtual makeup, or an apparatus for virtual makeup simulation prepared separately from the apparatus 100 for virtual makeup, and generate a makeup history based on the stored pieces of information about the virtual makeup process.

Here, makeup history may denote a set of pieces of information about a virtual makeup process, and a face model may denote a 2D image or a 3D image of a face.

For example, the processing unit 50 may store pieces of information about a skin care step, a primer step, a sun cream step, a makeup base step, a foundation step, a concealer step, a powder step, an eyebrow drawing step, an eyeshadow step, an eyeliner step, a mascara step, a lipstick step, a highlighter step, a shading step, etc. according to a sequence of virtual makeup. Based on such stored pieces of information, the processing unit 50 may generate a makeup history.

Here, the pieces of information about the virtual makeup process denote cosmetics information, makeup tool information, makeup stroke information, makeup area information, makeup intensity information, spectrum information, makeup time information, etc., and the processing unit 50 may store such pieces of information about the virtual makeup process according to passage of time.

The cosmetics information may include at least one of information about the type of cosmetics used in the virtual makeup process, information about cosmetics manufacturers, and information about cosmetic colors. In other words, the processing unit 50 may store pieces of information about the type of cosmetics used in the virtual makeup process, information about cosmetics manufacturers, and information about cosmetic colors, and generate cosmetics information including at least one of the stored pieces of information.

The makeup tool information may include information about the type of makeup tools used in the virtual makeup process, information about the sizes of the makeup tools, and so on. In other words, the processing unit 50 may store pieces of information about the type of makeup tools used in the virtual makeup process, and information about the sizes of the makeup tools, and generate makeup tool information including at least one of the stored pieces of information.

The makeup stroke information may denote position information dependent on movement of each of the makeup tools in the virtual makeup process. The processing unit 50 may present position information dependent on movement of a makeup tool in the form of (X, Y) in the case of a 2D face model, and in the form of (X, Y, Z) in the case of a 3D face model. Here, the processing unit 50 may generate position information dependent on movement of a makeup tool at predetermined time intervals, and generate makeup stroke information including the generated position information.

In addition, the makeup stroke information may include information about a start position and an end position of makeup applied using each of the makeup tools. For example, when start position information about makeup applied using a brush that is one of the makeup tools is (X1, Y1), and end position information about the makeup is (X2, Y2), the processing unit 50 may generate makeup stroke information including “(X1, Y1), (X2, Y2).”

The makeup area information may denote information about an area on a face model on which makeup is applied, and may be generated based on position information (i.e., makeup stroke information) dependent on movement of a makeup tool. Here, the area on which makeup is applied may denote an eye, a nose, a mouth, a cheek, a jaw, a forehead, etc. on the face model, and the area information may include at least one of an area, coordinates of the area, and coordinates of the central point of the area. The processing unit 50 may analyze position information dependent on movement of each makeup tool first, and generate makeup area information including at least one of an area on the face model indicated by the analyzed position information, coordinates of the area, and coordinates of the central point of the area.

For example, when makeup stroke information about a brush that is one of the makeup tools is “(X1, Y1), (X2, Y2),” the processing unit 50 may analyze an area indicated by “(X1, Y1), (X2, Y2)” on the face model, and when the area is analyzed to be a “cheek” area as a result, the processing unit 50 may generate the analysis result as makeup area information. Here, the processing unit 50 may generate makeup area information including at least one of the analyzed area, coordinates of the analyzed area, and coordinates of the central point of the analyzed area.

In addition, the makeup area information may include reference position information about at least one element constituting the face model, and vector information between pieces of the makeup area information. Elements constituting the face model may denote eyes, a nose, a mouth, ears, eyebrows, etc., and reference position information may denote the central point of each element constituting the face model. The vector information may include distance information between the central point of each element and the central point of the area indicated by the makeup area information, direction information from the central point of the element toward the central point of the area indicated by the makeup area information, and so on.

For example, when an element constituting the face model is an eye, and an area indicated by the makeup area information is a cheek, the processing unit 50 may generate distance information between the central point of the eye and the central point of the cheek, and direction information from the central point of the eye toward the central point of the cheek, and generate vector information including the generated distance information and the generated direction information.

The makeup intensity information may denote a pressure exerted on the face model using a makeup tool. The processing unit 50 may generate information about a pressure exerted on the face model using a makeup tool, and generate makeup intensity information including the generated pressure information.

The spectrum information may denote colors of the face model on which virtual makeup has been applied, and present the colors of the face model using a color model such as RGB or YCbCr. The processing unit 50 may analyze color information about the face model on which virtual makeup has been applied, and generate spectrum information including the analyzed color information.

The makeup time information may denote a time for which virtual makeup has been applied. The processing unit 50 may store information about a time for which each step of the virtual makeup process has been performed, information about a time for which cosmetics have been used, information about a time for which a makeup tool has been used, information about a time for which virtual makeup has been applied on the makeup area, and time information about strokes, and generate makeup time information including at least one of the stored pieces of time information.

The processing unit 50 may generate a makeup layer according to step S110 described above, and the makeup template generator 20 may also generate a makeup layer according to step S110 described above.

Specifically, the processing unit 50 may generate a makeup layer according to a relationship between at least one piece of information based on one of the cosmetics information, the makeup tool information, and the makeup area information. At this time, based on a relationship between a plurality of related pieces of information, the processing unit 50 may generate a makeup layer having a tree structure.

For example, when the processing unit 50 generates a makeup layer according to a relationship between at least one piece of information based on the cosmetics information, the makeup layer may include information about an arbitrary cosmetic, information about at least one makeup tool for applying virtual makeup using the arbitrary cosmetic, at least one piece of stroke information dependent on movement of each of the at least one makeup tool, and information about a makeup area indicated by each of the at least one piece of stroke information. In other words, the processing unit 50 may generate a makeup layer having a tree structure according to a relationship between a makeup tool, stroke information, a makeup area, etc. based on cosmetics.

When the processing unit 50 generates a makeup layer according to a relationship between at least one piece of information based on the makeup tool information, the makeup layer may include information about an arbitrary makeup tool for applying virtual makeup, information about at least one cosmetic used with the arbitrary makeup tool, at least one piece of stroke information dependent on movement of the arbitrary makeup tool used for the at least one cosmetic, and information about a makeup area indicated by each of the at least one piece of stroke information. In other words, the processing unit 50 may generate a makeup layer having a tree structure according to a relationship between cosmetics, stroke information, a makeup area, etc. based on makeup tools.

When the processing unit 50 generates a makeup layer according to a relationship between at least one piece of information based on the makeup area information, the makeup layer may include information about an arbitrary makeup area on which virtual makeup is applied, information about at least one cosmetic used for applying virtual makeup on the arbitrary makeup area, information about at least one makeup tool for applying virtual makeup using each of the at least one cosmetic, and at least one piece of stroke information dependent on movement of each of the at least one makeup tool. In other words, the processing unit 50 may generate a makeup layer having a tree structure according to a relationship between cosmetics, a makeup tool, and stroke information, etc. based on makeup areas.

The processing unit 50 may generate a makeup template according to step S120 described above, and the makeup template generator 20 may also generate a makeup template according to step S120 described above.

Specifically, the processing unit 50 may generate a makeup template by merging at least one makeup layer according to passage of time. For example, when makeup layer 1, makeup layer 2, makeup layer 3, and makeup layer 4 are generated in sequence according to passage of time, the processing unit 50 may generate a makeup template by merging makeup layer 1, makeup layer 2, makeup layer 3, and makeup layer 4 in sequence.

The processing unit 50 may extract makeup area information from the makeup template of the first face model, generate reference position information about at least one element constituting a second face model, set an area on the second face model on which makeup will be applied based on the makeup area information and the reference position information of the second face model, and apply virtual makeup on the area on which makeup will be applied based on the makeup template. Here, the first face model may denote a face model on which virtual makeup has already been applied, and the second face model may denote a face model on which virtual makeup will be newly applied.

The processing unit 50 may extract makeup area information according to step S300 described above, and the makeup area mapper 31 may also extract makeup area information according to step S300 described above.

Specifically, the processing unit 50 may extract the makeup area information from the makeup template according to a sequence of the virtual makeup process. Referring to FIG. 2 described above, the processing unit 50 may extract makeup area 1 included in the first makeup layer of the makeup template, then makeup area 2 included in the first makeup layer, then makeup area 1 included in the second makeup layer, then makeup area 2 included in the second makeup layer, and then makeup area 3 included in the second makeup layer.

The processing unit 50 may generate reference position information about the second face model according to step S310 described above, and the makeup area mapper 31 may also generate reference position information about the second face model according to step S310 described above.

Since elements constituting a face model denote eyes, a nose, a mouth, ears, eyebrows, etc., and reference position information denotes the central point of each element constituting the face model, the processing unit 50 may generate the central point of at least one element constituting the second face model, and reference position information including the generated central point.

The processing unit 50 may generate vector information according to step S321 described above, and the makeup area mapper 31 may also generate vector information according to step S321 described above.

Specifically, the processing unit 50 may generate distance information between the central points (i.e., reference position information) of respective elements (e.g., eyes, a nose, a mouth, ears, and eyebrows) constituting the first face model and the central point of the area (e.g., an eye, a nose, a mouth, a cheek, a jaw or a forehead) indicated by the makeup area information, and direction information from the central points of the respective elements constituting the first face model toward the central point of the area indicated by the makeup area information, and generate vector information including the generated distance information and the generated direction information. Here, when vector information is included in the makeup area information, the processing unit 50 may omit the step of generating vector information.

The processing unit 50 may map the vector information to the reference position information about the second face model according to step S322 described above, and the makeup area mapper 31 may also map the vector information to the reference position information about the second face model according to step S322 described above.

For example, when the vector information has been generated based on the central points of the eyes, noise, and mouth among the elements constituting the first face model, the processing unit 50 may map a first vector (i.e., a vector generated based on an eye of the first face model) to the central point of an eye that is an element constituting the second face model, a second vector (i.e., a vector generated based on the nose of the first face model) to the central point of a nose that is an element constituting the second face model, and a third vector (i.e., a vector generated based on the mouth of the first face model) to the central point of a mouth that is an element constituting the second face model.

The processing unit 50 may set an area on which makeup will be applied according to step S323 described above, and the makeup area mapper 31 may also set an area on which makeup will be applied according to step S323 described above.

Specifically, the processing unit 50 may set a point at which mapped vectors cross, or a point indicated by a mapped vector as an area on which virtual makeup will be applied. The processing unit 50 may set a point at which at least two vectors among the aforementioned first vector, second vector, and third vector cross as the central point of an area on which makeup will be applied. On the other hand, when there is no point at which the first vector, the second vector, and the third vector cross, the processing unit 50 may extend the first vector, the second vector, and the third vector in their longitudinal directions, and set a point at which at least two vectors among the extended first vector, the extended second vector, and the extended third vector cross as the central point of an area on which makeup will be applied.

The processing unit 50 may apply virtual makeup according to step S330 described above, and the virtual makeup applier 32 may also apply virtual makeup according to step S330 described above.

Specifically, the processing unit 50 may apply virtual makeup in a sequence of makeup layers included in the makeup template. Referring to FIG. 2, the processing unit 50 may apply virtual makeup based on the first makeup layer 210, then virtual makeup based on the second makeup layer 220, then virtual makeup based on the third makeup layer 230, and then virtual makeup based on the fourth makeup layer 240.

In other words, the processing unit 50 may apply virtual makeup on an area of the second face model corresponding to makeup area 1 based on cosmetics 1, makeup tool 1 and stroke information, and then apply virtual makeup on the area of the second face model corresponding to makeup area 1 based on cosmetics 1, makeup tool 2 and stroke information.

Here, the processing unit 50 may include a processor and a memory. The processor may denote a general-purpose processor (e.g., a central processing unit (CPU) and/or graphic processing unit (GPU)), or a dedicated processor for performing a method for virtual makeup. In the memory, a program code for performing a method for virtual makeup may be stored. In other words, the processor may read out the program code stored in the memory, and perform each step of the method for virtual makeup based on the read-out program code.

The storage 60 may store information to be processed, and information having been processed by the processing unit 50. For example, the storage 60 may store makeup history information, makeup layer information, makeup template information, face models, and so on.

The database 40 may perform substantially the same function as the storage 60, and store information to be processed and information having been processed by the makeup history generator 10, the makeup template generator 20, and the makeup applier 30. For example, the database 40 may store makeup history information, makeup layer information, makeup template information, face models, and so on.

According to example embodiments of the present invention, a virtual makeup operation can be carried out using a makeup template that is information about a virtual makeup process, and thus it is possible to rapidly carry out the virtual makeup operation. In other words, since a makeup process can be automatically performed using a virtual makeup template, it is possible to reduce the time taken for a virtual makeup operation in comparison with an existing virtual makeup operation of performing all makeup processes in detail.

While the example embodiments of the present invention and their advantages have been described in detail, it should be understood that various changes, substitutions and alterations may be made herein without departing from the scope of the invention.

What is claimed is:

1. A method for virtual makeup, comprising:
generating a virtual makeup history including pieces of information about a virtual makeup process;
generating virtual makeup layers based on a plurality of related pieces of information among the pieces of information stored in the virtual makeup history; and
generating a virtual makeup template by merging at least one of the virtual makeup layers.

2. The method for virtual makeup of claim 1, wherein the virtual makeup history includes at least one piece of information among cosmetics information, makeup tool information, makeup stroke information, makeup area information, makeup intensity information, spectrum information about a makeup-finished target, and makeup time is information.

3. The method for virtual makeup system of claim 2, wherein the makeup stroke information includes position information dependent on movement of a makeup tool.

4. The method for virtual makeup of claim 2, wherein the makeup area information includes information about an area corresponding to position information dependent on movement of a makeup tool.

5. The method for virtual makeup of claim 2, wherein the makeup area information includes reference position information about at least one element constituting a face model that is the makeup target, and vector information between pieces of the makeup area information.

6. The method for virtual makeup of claim 2, wherein generating the virtual makeup layers includes generating the virtual makeup layers based on a relationship between the at least one piece of information based on one of the cosmetics information, the makeup tool information, and the makeup area information.

7. The method for virtual makeup of claim 6, wherein the virtual makeup layers have a tree structure based on a relationship between the plurality of related pieces of information.

8. The method for virtual makeup of claim 1, wherein generating the virtual makeup template includes generating the virtual makeup template by merging the at least one virtual makeup layer according to passage of time.

9. A method for virtual makeup, comprising:
extracting makeup area information from a virtual makeup template including information about a virtual makeup process of a first face model;
generating reference position information about at least one element constituting a second face model;
setting an area on the second face model on which makeup will be applied based on the makeup area information and the reference position information; and
applying virtual makeup on the area on which makeup will be applied based on the virtual makeup template.

10. The method for virtual makeup of claim 9, wherein extracting the makeup area information includes extracting the makeup area information according to a sequence of the virtual makeup process.

11. The method for virtual makeup of claim 9, wherein setting the area on which makeup will be applied includes:
generating vector information about the makeup area information based on reference position information about at least one element constituting the first face model;
mapping the vector information to the reference position information of the second face model; and
setting an area defined by the mapped vector information as the area on which makeup will be applied.

12. The method for virtual makeup of claim 9, wherein the virtual makeup template includes at least one virtual makeup layer, and
the virtual makeup layer includes at least one piece of information among cosmetics information, makeup tool information, makeup stroke information, makeup area information, makeup intensity information, spectrum information about a makeup-finished target, and makeup time information.

13. The method for virtual makeup of claim 12, wherein applying the virtual makeup includes applying the virtual makeup on the area on which makeup will be applied based on the at least one virtual makeup layer included in the virtual makeup template.

14. The method for virtual makeup of claim 12, wherein applying the virtual makeup includes applying the virtual makeup on the area on which makeup will be applied based on the virtual makeup layer according to a sequence of the virtual makeup process performed on the first face model.

15. An apparatus for virtual makeup, comprising:
a makeup history generator configured to generate a virtual makeup history including pieces of information about a virtual makeup process of a first face model;
a makeup template generator configured to generate virtual makeup layers based on a plurality of related pieces of information among the pieces of information stored in the virtual makeup history, and generate a virtual makeup template by merging at least one of the virtual makeup layers; and
a database configured to store information to be processed, and information having been processed by the makeup history generator and the makeup template generator.

16. The apparatus for virtual makeup of claim 15, wherein the virtual makeup history includes at least one piece of information among cosmetics information, makeup tool information, makeup stroke information, makeup area information, makeup intensity information, spectrum information about a makeup-finished target, and makeup time information.

17. The apparatus for virtual makeup of claim 16, wherein the makeup template generator generates the virtual makeup layers based on a relationship between the at least one piece of information based on one of the cosmetics information, the makeup tool information, and the makeup area information.

18. The apparatus for virtual makeup of claim 16, wherein the makeup stroke information includes position information dependent on movement of a makeup tool.

19. The apparatus for virtual makeup of claim 16, wherein the makeup area information includes information about an area corresponding to position information dependent on movement of a makeup tool.

20. The apparatus for virtual makeup of claim 15, further comprising a makeup applier configured to extract makeup area information from the virtual makeup template of the first face model, generate reference position information about at least one element constituting a second face model, set an area on the second face model on which makeup will be applied based on the makeup area information and the reference position information of the second face model, and apply virtual makeup on the area on which makeup will be applied based on the virtual makeup template.
